(19) United States
(12) Patent Application Publication
(10) Pub. No.: US 2011/0249833 A1
(43) Pub. Date: Oct. 13, 2011

(54) PRENATAL SOUND DELIVERY SYSTEM

(76) Inventor: David Shin, Brooklyn, NY (US)

(21) Appl. No.: 12/757,176

(22) Filed: Apr. 9, 2010

(51) Int. Cl. H04R 25/00

(52) U.S. Cl. 381/151

(57) ABSTRACT

A flexible band may be worn around the stomach of a pregnant woman. The band may have speakers safely and comfortably integrated therein to provide sound to prenatal babies. The speakers may connect to a mp3 player that may be stored in a pocket in the band.

### BACKGROUND OF THE INVENTION

The present invention relates to prenatal baby care and, more particularly, to an apparatus to safely and comfortably deliver sound to prenatal babies.

The ear first appears in the 3^{rd} week of gestation and it becomes functional by the 16^{th} week. The fetus begins active listening by the 24^{th} week. It is known from ultrasound observations that the fetus hears and responds to a sound pulse starting about 16 weeks of age. This is even before the ear construction is complete. The cochlear structures of the ear appear to function by the 20^{th} week and mature synapses have been found between the 24^{th} and 28^{th} weeks. The sense of hearing is probably the most developed of all the senses before birth. The powerful connection between sound/music and prenatal memory/learning has been revealed in formal experiments, parental observations, clinical records, and first person reports.

As can be seen, there is a need for a safe and comfortable apparatus to deliver sound to prenatal babies.

### SUMMARY OF THE INVENTION

In one aspect of the present invention, a prenatal sound system comprises a flexible band fitting around the abdomen of a user; at least one speaker integrated into the flexible band; a pocket in the flexible band for housing a portable sound playing device; and a wire for connecting the speakers to the portable sound playing device.

In another aspect of the present invention, a prenatal sound system comprises a flexible band fitting around the abdomen of a user; first and second water resistant speakers housed in a vinyl housing and integrated into the flexible band; a pocket stitched onto the flexible band for housing a portable sound playing device; and a wire connecting to the speakers at a first end thereof, the wire adapted to electrically connect the speakers to the portable sound playing device.

These and other features, aspects and advantages of the present invention will become better understood with reference to the following drawings, description and claims.

### BRIEF DESCRIPTION OF THE DRAWINGS

FIG. 1 is a perspective view of a sound delivery system according to an embodiment of the present invention;

FIG. 2 is a side view of the sound delivery system of FIG. 1;

FIG. 3 is a top view of the sound delivery system of FIG. 1;

FIG. 4 is a front view of the sound delivery system of FIG. 1 with its outer sheet of material removed;

FIG. 5 is a front view of the sound delivery system of FIG. 1; and

FIG. 6 is a back view of the sound delivery system of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention provides a band worn around the stomach of a pregnant woman. The band may have speakers safely and comfortably integrated therein to provide sound to prenatal babies.

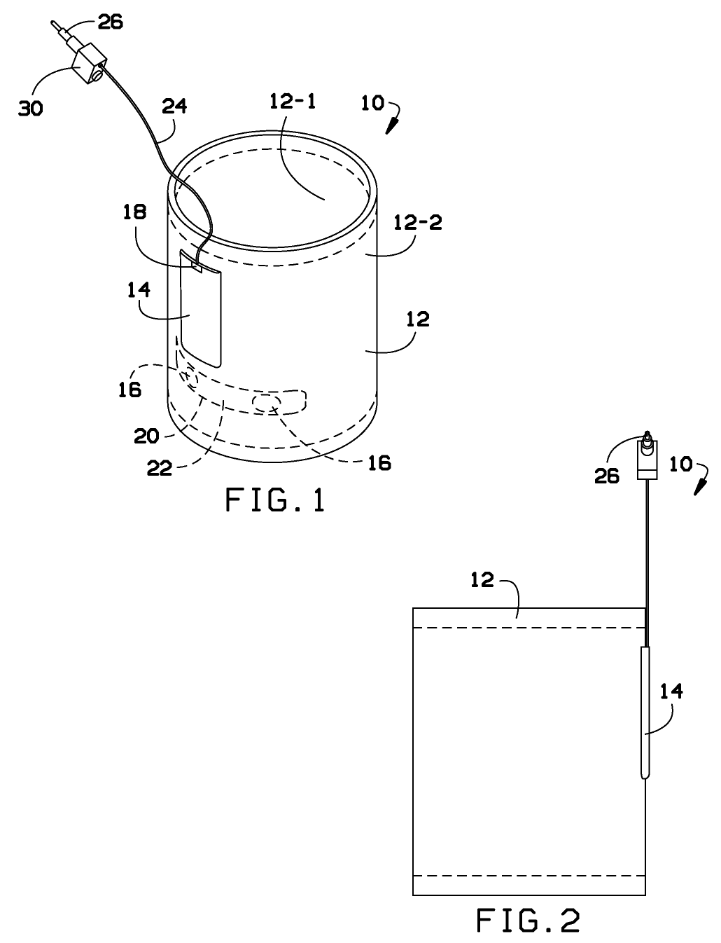

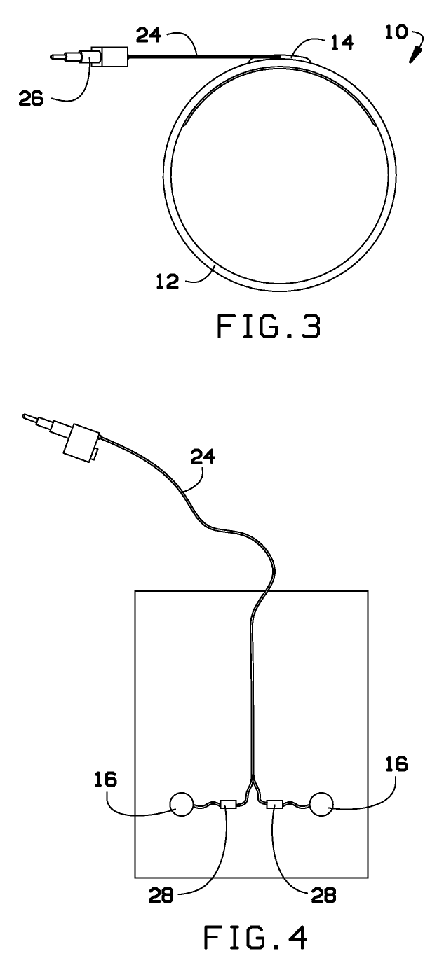

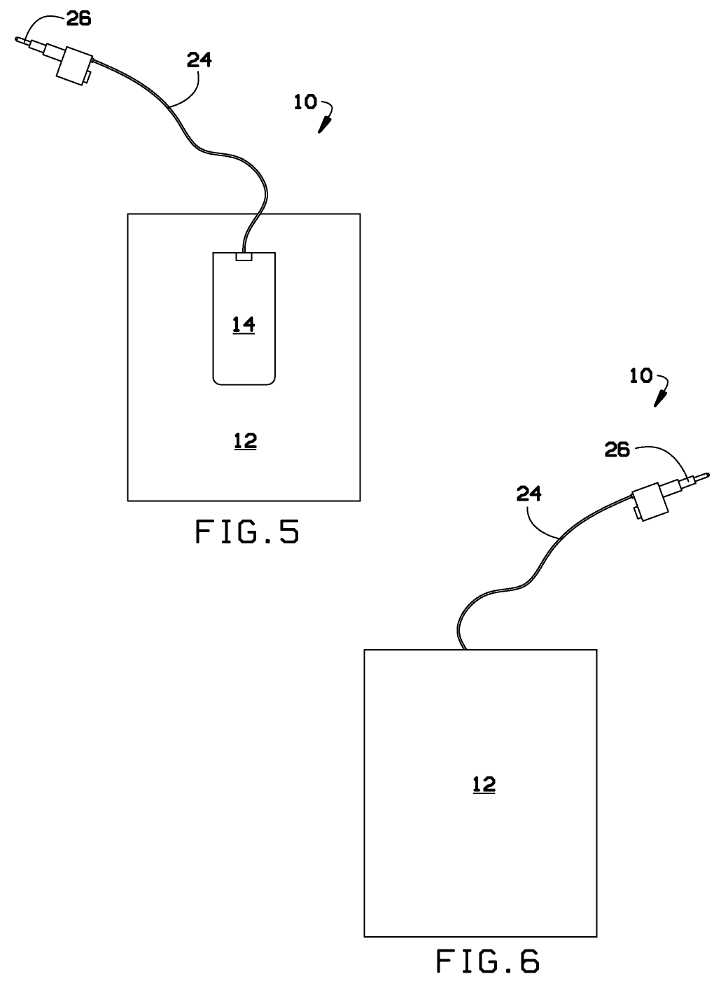

Referring to FIGS. 1 through 5, a sound delivery system 10 may include a flexible band 12 having a pocket 14 formed therein. The flexible band 12 may be formed of Lycra®, spandex or any similar flexible material. The flexible band 12 may be machine washable and may have sufficient elasticity to stretch to fit a user. The flexible band 12 may be formed by stitching together inner and outer sheets of flexible material 12-1, 12-2. The flexible band 12 may be a closed loop designed for a user to step into, for example. In an alternate embodiment, the flexible band may be designed to be wrapped around the user and attach with, for example, hook and loop fasteners.

The pocket 14 may be attached to the flexible band 12 by conventional means. For example, the pocket 14 may be stitched to at least the outer sheet of flexible material 12-2. The pocket 14 may be sized to hold a portable sound playing device, such as a mp3 player. The pocket 14 may have a closure 18, such as a hook and loop fastener (Velcro® for example), to prevent the music playing device from unintentionally exiting the pocket 14 and to hold the cord during machine and or hand washing.

The flexible band 12 may have at least one mini-speaker 16. In a typical embodiment, two mini-speakers 16 may be disposed between inner and outer sheets 12-1, 12-2 of material. The mini-speakers may be a conventional design with a mylar cone and may be water resistant. The mini-speakers 16 may have a metal housing and the magnet used may be neodymium (Nd) magnets. The mini-speakers 16 may weigh from about 1.5 to about 2.5 grams, typically about 1.8 grams. The mini-speakers 16 may use a voltage between about 0.2 to about 0.5 watts with a maximum decibel level (dBA) of about 88 sound pressure. The voltage may be selected to allow the speakers 16 to run without a separate power source and without draining an independently powered sound device. The speakers 16 may have low heat output to ensure the safety and comfort of the user. Alternate designs for the speakers 16 may be available. As examples of alternate designs, the speakers 16 may have a plastic housing, a paper cone, or may use neodymium-iron-boron (Nd—Fe—B) magnets. The speakers may be contained between the inner and outer sheets 12-1, 12-2 by stitching 20. The stitching 20 may create an inner pocket 22 to limit movement of the speakers 16 between the inner and outer sheets 12-1, 12-2.

The speakers 16 may be electrically attached to a wire 24. The wire 24 may have a connector 26 at one end thereof. The connector 26 may be, for example, a ⅛″ male stereo connector. The connector may include a female stereo connector 30 to allow a person to attach an external speaker (not shown), such as headphones, so that they may be able to listen to the same sounds as the prenatal baby. The wire 24 may be an insulated braided copper wire, for example. The wire 24 may be long enough to allow the connector 26 to extend from the pocket 14 of the flexible band 12.

The wire 24 may include at least one resistor 28 in series between the connector 26 and the speakers 16. The resistor 28 may limit the number of decibels allowed through the speakers to, for example, about 75 dBA. A variety of resistors 28 may be used to coordinate with the selected speakers 16, depending on the wattage of the chosen speakers.

The speakers 16 may be covered with a casing (not shown) such as vinyl A vinyl casing on the speakers 16 may help cover, insulate and increase the speakers' resistance to moisture.

It should be understood, of course, that the foregoing relates to exemplary embodiments of the invention and that modifications may be made without departing from the spirit and scope of the invention as set forth in the following claims.

We claim:

1. A prenatal sound system comprising:
a flexible band configured to fit around an abdomen of a user;
at least one speaker integrated into the flexible band;
a pocket in the flexible band for housing a portable sound playing device connected to the at least one speaker.

2. The prenatal sound system of claim 1, wherein the at least one speaker is two speakers.

3. The prenatal sound system of claim 1, wherein the speakers are housed in a vinyl casing.

4. The prenatal sound system of claim 1, wherein the flexible band is formed from an inner sheet of material and an outer sheet of material.

5. The prenatal sound system of claim 4, wherein the at least one speaker is contained in a pocket formed be stitching the inner sheet to the outer sheet.

6. The prenatal sound system of claim 1, further comprising at least one resistor to control the decibel level of the speakers to a predetermined maximum.

7. The prenatal sound system of claim 1, wherein the speakers are water resistant.

8. The prenatal sound system of claim 1, wherein the flexible band forms a closed loop.

9. A prenatal sound system comprising:
a flexible band configured to fit around the abdomen of a user;
first and second water resistant speakers housed in a vinyl housing and integrated into the flexible band;
a pocket stitched onto the flexible band for housing a portable sound playing device connected to the speakers.

10. The prenatal sound system of claim 9, further comprising:
a male connector at a second end of the wire, the male connector adapted to connect the wire to the portable sound playing device; and
a female connector at the second end of the wire, the female connector adapted to connect an external speaker to the portable sound playing device.
